(19) United States
(12) Patent Application Publication
(10) Pub. No.: US 2017/0149854 A1
(43) Pub. Date: May 25, 2017

(54) Communication System

(71) Applicant: Microsoft Technology Licensing, LLC, Redmond, WA (US)

(72) Inventors: Ben Dove, Redmond, WA (US); Mohammed Ladha, London (GB); Lee Pethers, Redmond, WA (US); Hando Tint, Tartu (EE); Alex Usbergo, Redmond, WA (US)

(73) Assignee: Microsoft Technology Licensing, LLC, Redmond, WA (US)

(21) Appl. No.: 15/356,064

(22) Filed: Nov. 18, 2016

(30) Foreign Application Priority Data
Nov. 20, 2015 (GB) 1520520.6

(51) Int. Cl. H04L 29/06; G06F 3/14; G06F 3/0482

(52) U.S. Cl. CPC H04L 65/403; G06F 3/0482; G06F 3/14; G06F 2203/04803; G06T 3/40

(57) ABSTRACT

There is provided a method comprising: allocating each user participating in a multi-user call to a first group, a second group, or a third group in dependence on a respective first priority associated with each user; causing a display to render image data representative of respective users in the first group in a primary area of the display and to render image data representative of respective users in the second group in a secondary area of the display, wherein users in a third group do not have image data rendered in either of the primary and secondary areas; and re-allocating each user participating in the multi-user call to the first group, the second group, or the third group in dependence on a respective second priority associated with each user, such that users immediately previously allocated to the third group are not re-allocated to the first group.

### PRIORITY APPLICATIONS

This application claims priority under 35 USC 119 or 365 to Great Britain Application No. 1520520.6 filed Nov. 20, 2015, the disclosure of which is hereby incorporated by reference in its entirety.

### FIELD OF THE INVENTION

The present invention relates to a method, an apparatus and a computer program product.

### BACKGROUND

A conversation visualisation environment is an environment operating on a device that causes graphical content associated with an exchange between users to be rendered on a display to one of the users performing the exchange. Conversation visualisation environments allow conversation participants to exchange communications in accordance with a variety of conversation modalities. For example, participants may engage in video exchanges, voice calls, instant messaging, white board presentations, and desktop views of other modes.

As the feasibility of exchanging conversation communications by way of a variety of conversation modalities has increased, so too have the technologies with which participants may engage in a video call using traditional desktop or laptop computers, tablets, phablets, mobile phones, gaming systems, dedicated conversation systems, or any other suitable communication device. Different architectures can be employed to deliver conversation visualisation environments, including centrally managed and peer-to-peer architectures.

Many conversation visualisation environments provide features that are dynamically enabled or otherwise triggered in response to various events. For example, emphasis may be placed on one particular participant or another in a gallery of video participants based on which participant is speaking at any given time. Other features give participants notice of incoming communications, such as a pop-up bubble alerting a participant to a new chat message, video call, or voice call.

### SUMMARY

During a video call, the conversation visualisation environment may render visual data (such as dynamic or static-image data) associated with a user on a display screen so as to indicate or otherwise represent the presence of the user on the call. For example, if Alice is talking to Bob and Charlie on a video call, the conversation visualisation environment may cause real-time (or near real-time) videos produced by Bob and Charlie's respective user terminals to be rendered on a display screen controlled by Alice's user equipment.

The inventors have realised that the layout/configuration of the display of visual data can change in response to immediate events, which can require an inefficient use of computing resources to repeatedly change how things are rendered on the display.

The inventors have further realised that such an arrangement may be an inefficient use of space on a display screen.

Accordingly, according to a first aspect, there is provided a method comprising: allocating each user participating in a multi-user call to a first group, a second group, or a third group in dependence on a respective first priority associated with each user; causing a display to render image data representative of respective users in the first group in a primary area of the display and to render image data representative of respective users in the second group in a secondary area of the display, wherein users in a third group do not have image data rendered in either of the primary and secondary areas; re-allocating each user participating in the multi-user call to the first group, the second group, or the third group in dependence on a respective second priority associated with each user, such that users immediately previously allocated to the third group are not re-allocated to the first group.

There is further provided a user terminal comprising: at least one processor; and at least one memory comprising code that, when executed on the at least one processor, causes the user terminal to: allocate each user participating in a multi-user call to a first group, a second group, or a third group in dependence on a respective first priority associated with each user; cause a display to render image data representative of respective users in the first group in a primary area of the display and to render image data representative of respective users in the second group in a secondary area of the display, wherein users in a third group do not have image data rendered in either of the primary and secondary areas; and re-allocate each user participating in the multi-user call to the first group, the second group, or the third group in dependence on a respective second priority associated with each user, such that users immediately previously allocated to the third group are not re-allocated to the first group.

There is further provided a user terminal comprising: at least one processor; and at least one memory comprising code that, when executed on the at least one processor, causes the user terminal to perform any of the steps of the above-mentioned method.

There is further provided a computer program product comprising computer executable instructions, which when executed by a computer, cause the computer to perform each of the method of any of claims 1 to 18.

### FIGURES

For a better understanding of the subject matter and to show how the same may be carried into effect, reference will now be made by way of example only to the following drawings in which:

FIG. 1 is a schematic illustration of a communication system;

FIG. 2 is a schematic block-diagram of a user terminal;

FIG. 3 is a flowchart illustrating actions that may be performed by a user terminal;

FIGS. 4, 5A, 5B, 5C, 5D, and 5E illustrate potential displays of a conversation visualisation environment;

FIG. 6 is a flowchart illustrating actions that may be performed by a user terminal; and

FIG. 7 illustrates a graph showing sound level versus time.

### DESCRIPTION

The present application is directed towards utilising the processing capabilities of a mobile terminal more efficiently. In particular, the present application is directed towards reducing the frequency in changing the visual data associated with respective users on a multi-user call that is being rendered on a display.

To this effect, the following discloses a user terminal configured to control a rendering of visual data on an associated display.

The user terminal comprises at least one processor and at least one memory comprising computer code for this purpose. When executed on the at least one processor, the computer code causes the user terminal to present a conversation visualisation environment relating to a multi-user call. The conversation visualisation environment is an environment operating on a device (through execution of the appropriate code) that causes graphical content associated with an exchange between users (e.g. an audio-visual call) to be rendered on a display to at least one of the users participating in the exchange.

The visual data is associated with respective users on a multi-user call. By this, it is meant that visual data associated with a user can be used to represent its respective user when the visual data is rendered on a display. The visual data may be static image data (e.g. an icon or a photo) and/or dynamic image data (such as a video or gif). The visual data may identify the user in some way (for example, using their name and/or an avatar). Image data in the visual data may be used to represent a user on the call. The image data may uniquely identify a user on the call. By this, it is meant that the image data uniquely identifies one of the users on the call. The image data may comprise a static-image and/or a dynamic-image, with text string superposed over at least part of the image. The visual data to be used for rendering on a display screen may be indicated to a user terminal over the network. For example, the user terminal may subscribe to video streams for at least some of those users who visual data it is rendering. The network may also in addition or in the alternate indicate another image to be used as visual data.

The user terminal is configured to determine a priority associated with each user participating in the multi-user call. The priority may be linked to activity levels associated with each user, such that users who are more active on the multi-user call (e.g. those users that speak the most, and/or share files/presentations and/or send messages in the conversation visualisation environment hosting the call) have a higher priority. The priority is used by the user terminal to determine which visual data should be rendered on the display, and which visual data should not be rendered on the display. A predetermined set of logic in the conversation visualisation environment may be used to determine this.

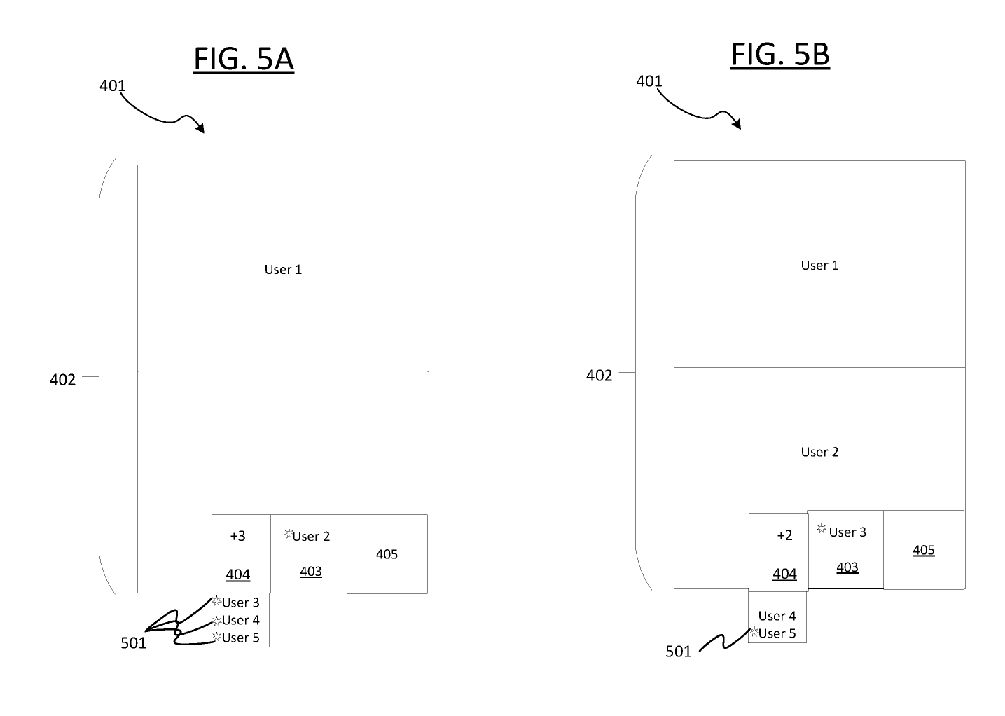

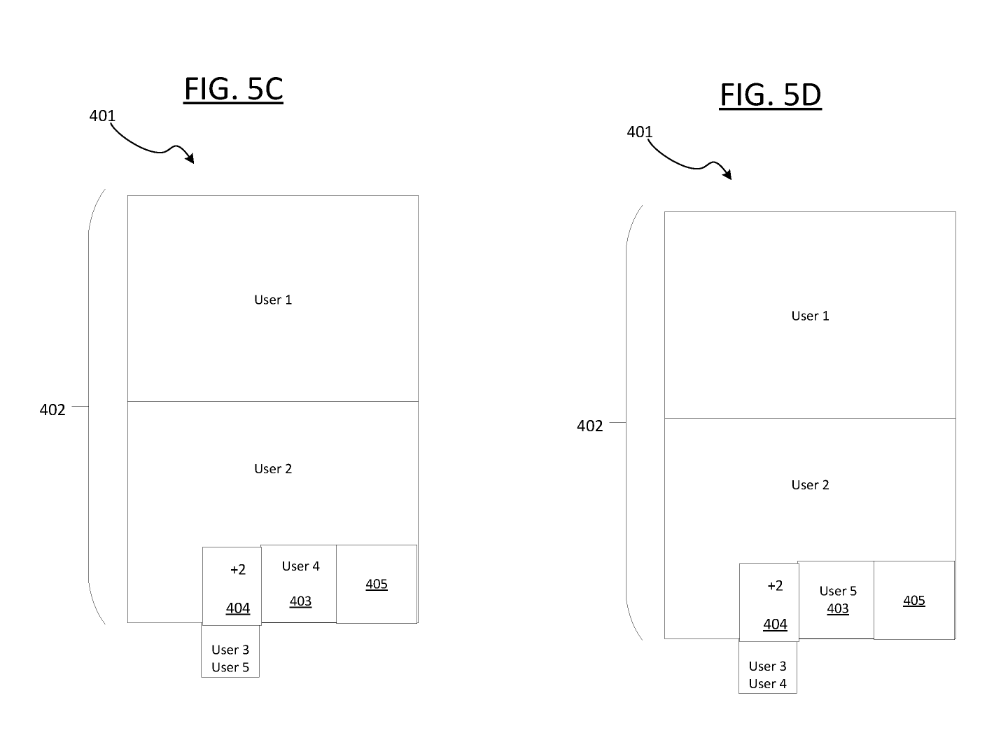

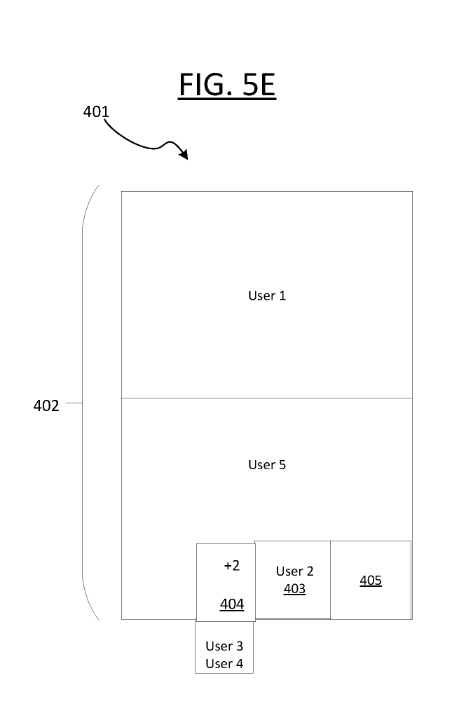

The user terminal is configured to group the users on the multi-user call into at least three distinct groups, in dependence on their priority. In other words, the user terminal is configured to allocate each user participating in a multi-user call to a first group, a second group, or a third group in dependence on a respective first priority associated with each user. The groups may be: high priority users (consisting of a number of users having the highest priority); low priority users (consisting of a number of users having the lowest priority); and intermediate priority users (consisting of a number of users having a priority between the lowest priority in the high priority users group and the highest priority in the low priority users group). It is understood that the number of users having “the lowest priority” (and, by extension, the “highest priority”) does not necessarily refer to a set of users all having the same priority. As illustrated in the example below (with reference to FIGS. 5A to 5E), users having the same associated priority may be placed in different groups. This placement may be done using a pseudorandom selection process and/or using some other type of selection mechanism.

For the high priority users group, visual data relating to those users are displayed in a main stage (primary) area of the conversation visualisation environment. The main stage area of the conversation visualisation environment takes up the majority of the space on the display that is designated by the conversation visualisation environment for rendering the visual data associated with a multi-user call. For the intermediate priority users group, visual data relating to those users are displayed in a secondary area of the conversation visualisation environment, the secondary area being smaller than the main stage area. In an embodiment, only one user is in the intermediate priority users group. For the low priority users group, a visual summary of the low priority users group may be displayed in a tertiary area of the display, the tertiary area being smaller than the main stage area. In other words, the user terminal may be caused to cause a display to render image data representative of respective users in the first group in a primary area of the display and to render image data representative of respective users in the second group in a secondary area of the display, wherein users in a third group do not have image data rendered in either of the primary and secondary areas.

In an embodiment, the secondary area is used to prevent low priority users from the tertiary area (i.e. those users who are not very active in contributing to the call) having their visual data rendered in the main area of the conversation visualisation environment as soon as those users start to become more active (for example, when a user says a sentence or two). Users grouped in the low priority user group may only move up to the intermediate priority user group area following an increase in their activity level. Therefore, the user terminal may be caused to re-allocate each user participating in the multi-user call to the first group, the second group, or the third group in dependence on a respective second priority associated with each user, such that users immediately previously allocated to the third group are not re-allocated to the first group. In other words, users grouped in the low priority user group cannot go from being summarised in the tertiary area to being rendered in the primary/main stage area without first being rendered in the secondary area. Users grouped in the intermediate priority user group may move to the high priority users group when they continue to be more active (i.e. have a higher priority level) than the least active user in the high priority users group. Users grouped in the intermediate priority group may move to the low priority users group when they become less active (i.e. have a lower priority level) than the most active user in the low priority group. The priorities/activity levels may be compared only when an activity happens. The priorities/activity levels may be compared periodically throughout the call. The priorities might be weighted so that events that happened less recently either do not affect the priority of (or affect the priority less than) a user. The priorities/levels may be compared both periodically throughout the call as well as when an activity occurs.

In this manner, the intermediate priority users group may prevent users from being promoted between the tertiary and main stage areas too quickly. This allows for the user terminal to save on processing power due to frequent changes to the configuration of visual data on the display.

In order that the environment in which the present system may operate be understood, by way of example only, we describe a potential communication system and user equipment into which the subject-matter of the present application may be put into effect. It is understood that the exact layout of this network is not limiting.

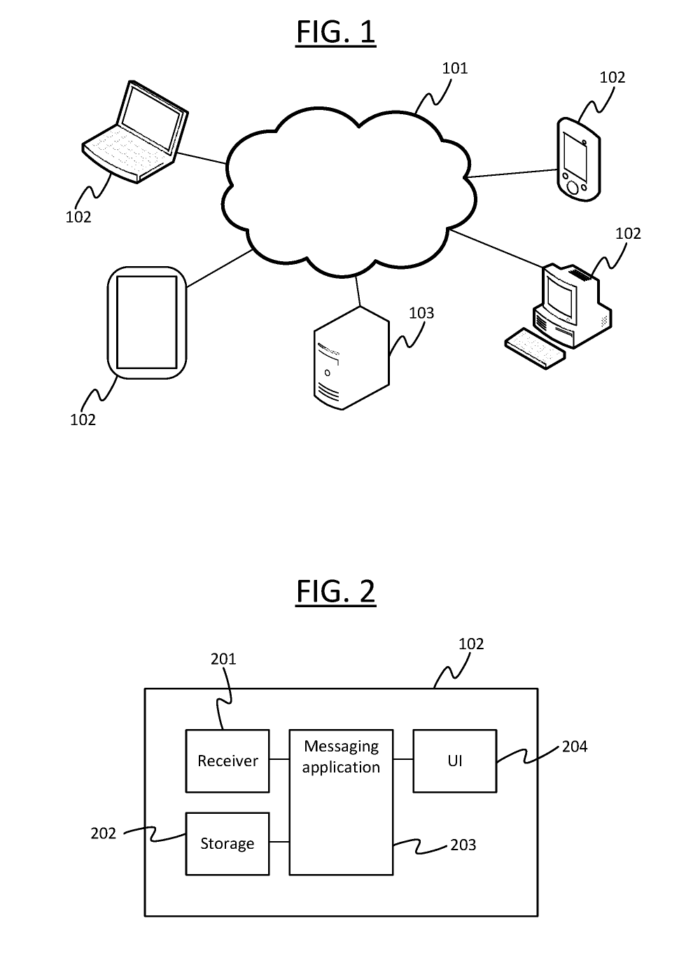

FIG. 1 shows an example of a communication system in which the teachings of the present disclosure may be implemented. The system comprises a communication medium 101, in embodiments a communication network such as a packet-based network, for example comprising the Internet and/or a mobile cellular network (e.g. 3GPP network). The system further comprises a plurality of user terminals 102, each operable to connect to the network 101 via a wired and/or wireless connection. For example, each of the user terminals may comprise a smartphone, tablet, laptop computer or desktop computer. In embodiments, the system also comprises a network apparatus 103 connected to the network 101. It is understood, however, that a network apparatus may not be used in certain circumstances, such as some peer-to-peer real-time communication protocols. The term network apparatus as used herein refers to a logical network apparatus, which may comprise one or more physical network apparatus units at one or more physical sites (i.e. the network apparatus 103 may or may not be distributed over multiple different geographic locations).

FIG. 2 shows an example of one of the user terminals 102 in accordance with embodiments disclosed herein. The user terminal 102 comprises a receiver 201 for receiving data from one or more others of the user terminals 102 over the communication medium 101, e.g. a network interface such as a wired or wireless modem for receiving data over the Internet or a 3GPP network. The user terminal 102 also comprises a non-volatile storage 202, i.e. non-volatile memory, comprising one or more internal or external non-volatile storage devices such as one or more hard-drives and/or one or more EEPROMs (sometimes also called flash memory). Further, the user terminal comprises a user interface 204 comprising at least one output to the user, e.g. a display such as a screen, and/or an audio output such as a speaker or headphone socket. The user interface 204 will typically also comprise at least one user input allowing a user to control the user terminal 102, for example a touch-screen, keyboard and/or mouse input.

Furthermore, the user terminal 102 comprises a messaging application 203, which is configured to receive messages from a complementary instance of the messaging application on another of the user terminals 102, or the network apparatus 103 (in which cases the messages may originate from a sending user terminal sending the messages via the network apparatus 103, and/or may originate from the network apparatus 103).

The messaging application is configured to receive the messages over the network 101 (or more generally the communication medium) via the receiver 201, and to store the received messages in the storage 202. For the purpose of the following discussion, the described user terminal 102 will be considered as the receiving (destination) user terminal, receiving the messages from one or more other, sending ones of the user terminals 102. Further, any of the following may be considered to be the entity immediately communicating with the receiver: as a router, a hub or some other type of access node located within the network 101. It will also be appreciated that the messaging application 203 receiving user terminal 102 may also be able to send messages in the other direction to the complementary instances of the application on the sending user terminals and/or network apparatus 103 (e.g. as part of the same conversation), also over the network 101 or other such communication medium.

The messaging application may transmit audio and/or visual data using any one of a variety of communication protocols/codecs. For example, audio data may be streamed over a network using a protocol known Real-time Transport Protocol, RTP (as detailed in RFC 1889), which is an end-to-end protocol for streaming media. Control data associated with that may be formatted using a protocol known as Real-time Transport Control Protocol, RTCP (as detailed in RFC 3550). Session between different apparatuses may be set up using a protocol such as the Session Initiation Protocol, SIP.

The following discusses particular embodiments of the presently described system. It is understood that various modifications may be made within these embodiments without exceeding the scope of the claimed invention.

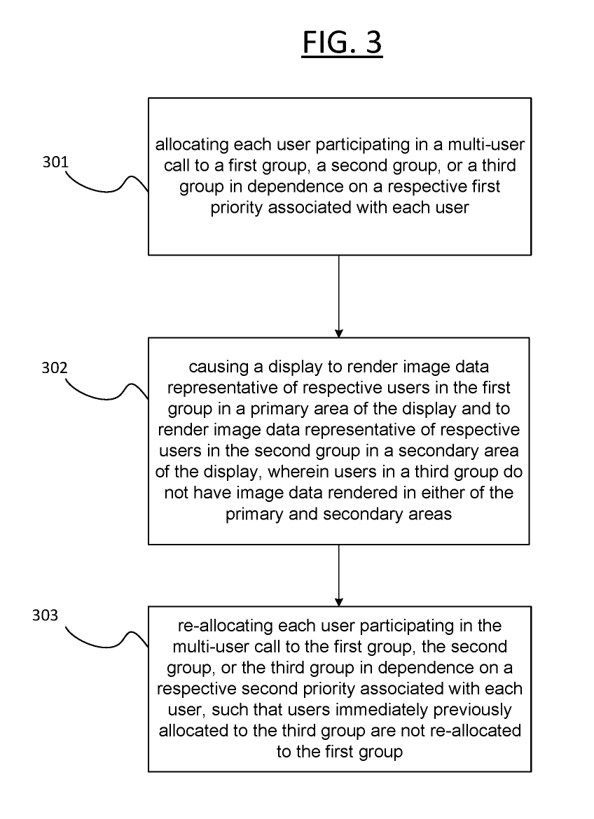

The following is discussed with reference to the flow chart of FIG. 3, which illustrates various actions that may be taken by a user terminal on executing code using at least one processor. It is understood, however, that these actions may be executed by a network apparatus (such as centralised server), following execution of code on a processor controllable by the network apparatus.

At step 301, the user terminal is configured to allocate each user participating in a multi-user call to a first group, a second group, or a third group in dependence on a respective first priority associated with each user. In other words, the user terminal is configured to associate a priority with each user participating in a multi-user call, each user being associated with respective visual data. The association may be based on respective priorities regarding each user received from a network apparatus, such as the centralised server, or may be based on a computation and/or calculation performed by the user terminal itself. As mentioned above, the priority may be indicative of an activity level of the user during the multi-user call, with more active users (e.g. those who speak more frequently and/or share files through the conversation visualisation environment hosting the multi-user call) being accorded a higher priority that less active users. The activity level may comprise more than simply an indication of audio data, however. For example, the activity level may be determined based on other conversation-related activities performed by a user during the call. For example, the activity level may be further determined in dependence on at least one of: sharing a file; the time since a user joined the call; and the amount of audio data less than a predetermined length (i.e. a brief interjection by a user).

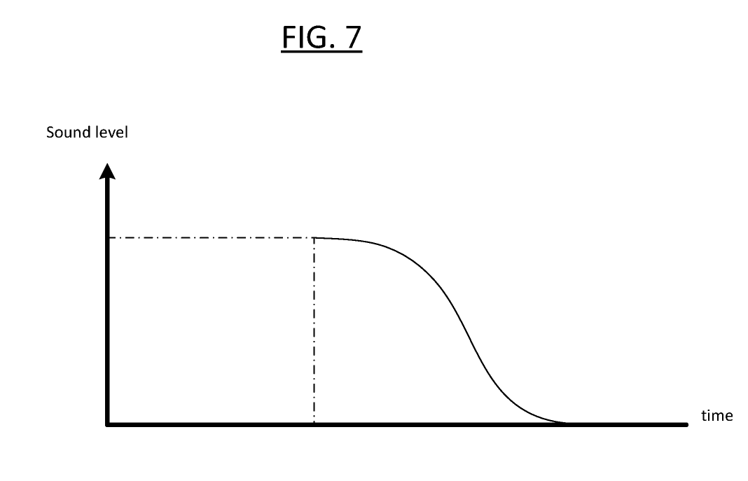

In an embodiment, the user terminal is configured to compute a priority for a user as the integral of the sound level over time, where the sound level represents the amount of audio data being received for a respective user. When the sound level goes to 0 (i.e., the user stops speaking), this may be modelled as a smooth transition over an interval dependent on the frequency with which the priority is determined. For example, if the priority is determined periodically every 10 seconds, when a user stops speaking, their associated sound level is depicted as a curve (e.g. a sine wave) over 20 seconds from their previous sound level to zero. This is shown with respect to FIG. 7.

FIG. 7 is a graph illustrating sound level on the y axis and time on the x axis. The actual sound level of the user is depicted as a dotted line. At a particular time, the sound level of the user drops from its active level to zero. At this point, the sound level is instead actually modelled as a curve that reaches zero at twice the update frequency of the priorities. For the sake of determining the priority of the user, which is dependent on the integral of this sound level function, the curve is used after the user sound level drops to zero. This helps to prevent the user terminal from demoting a user to a lower priority too quickly.

At step 302, the user terminal is configured to cause a display to render image data representative of respective users in the first group in a primary area of the display and to render image data representative of respective users in the second group in a secondary area of the display, wherein users in a third group do not have image data rendered in either of the primary and secondary areas. In other words, the user terminal is configured to control a display to render the visual data of a first number of users in a primary area of the display in dependence on the determined priority. The first number may be set by the user and/or depend on the display properties of the screen. For example, the first number may be determined by the user terminal in dependence on the total size of the display allocated to rendering visual data relating to the multi-user call. The number may be constrained by the aspect ratio of the window provided by the conversation visualisation environment for rendering the user data on the display. As another example, in the alternate or in addition to the previous example, the first number may be determined by the user terminal in dependence on an input from the user of the user device specifying a number of users to render visual data for in the primary area of the display. This mentioned display is usually an area depicted on a physical screen within which a conversation visualisation environment renders information relating to a particular multi-user call.

The user terminal is configured to control the display to render the visual data of at least one other user in a secondary area of the display in dependence on the determined priority. The primary area of the display is larger than the second area of the display.

The user terminal may be configured to control the display to render, in a tertiary area of the display, a summary of users whose visual data is not rendered on the display in either the primary or secondary areas. The summary may include information identifying every user on the multi-user call, only some of the users on the multi-user call or may include information identifying only those users whose image data is not currently being rendered on the display. The summary may take any of a variety of forms. One possible form is a graphical illustration of the number of users on the multi-user call whose associated visual data is not being rendered in the primary and secondary areas. For example, if there are 7 people on a call, but visual data for only 3 people is rendered on the display, the summary may simply display “+4” to indicate that there are 4 users whose visual data is not being rendered on the display in the primary and secondary areas. Another possible form is that of a drop down box. The drop down box may be activated (via an appropriate link on the screen) such that, on activation, information identifying all of the users on the multi-user call whose associated visual data is not being rendered in the primary and secondary areas. Another possible form is that of a scrollable list of information identifying the users on the multi-user call whose associated visual data is not being rendered in the primary and secondary areas. These possible embodiments are not limiting.

In step 303, the user terminal is configured to re-allocate each user participating in the multi-user call to the first group, the second group, or the third group in dependence on a respective second priority associated with each user, such that users immediately previously allocated to the third group are not re-allocated to the first group. In other words, the user terminal may re-allocate users into new groups in dependence on an updated priority.

For example, the user terminal may be configured to determine a new priority for least a second user whose visual data is being rendered in the secondary area of the display. The user terminal may be configured to compare the priority of a first user in the first number of users with the new priority of the second user.

In response to determining that the new priority of the second user is higher than the priority of said first user, the user terminal controls the display to render the visual data associated with the first user in the secondary area and the visual data of the second user in the primary area. When it is determined that the new priority of the second user is higher than the priority of said first user, the user terminal may be configured to obtain a higher resolution of visual data associated with the second user (i.e. the user whose visual data was previously being rendered in the secondary area). This may be achieved by the user terminal transmitting a request to a network entity to receive higher resolution visual data associated with said second user than is currently being received. Further, in this case, as the user terminal no longer requires to receive the same resolution of the visual data associated with the first user (as it is being changed from being rendered in a main/primary area of the screen to a smaller area of the screen), the user terminal may transmit a request to the network entity to receive lower resolution visual data associated with said first user than is currently being received. This helps to reduce congestion in the network, as fewer layers of video data need to be transmitted (or fewer bits in general) than if full resolution was received for every rendered visual data.

In response to determining that the new priority of the second user is the same as and/or lower than the priority of said first user, the user terminal does not control the display to render the visual data associated with the first user in the secondary area and the visual data of the second user in the primary area. In other words, the user terminal does not change the configuration/layout of the rendered visual data in response to a determination that said first new priority is the same as and/or lower than the priority of said first user. Thus, in this case, the configuration on the display in which visual information associated with the users is displayed remains unchanged.

The user terminal may be further configured to determine a new priority for least a third user having a summary of its visual data rendered in the tertiary area of the display. The user terminal may be configured to compare the new priority of the third user with a priority of a fourth user having visual data rendered in the secondary area of the display.

In response to determining that the new priority of the third user is higher than the priority of said fourth user, the user terminal controls the display to render a summary of the visual data associated with said fourth user in the tertiary area of the display and rendering the visual data associated with said third user in the secondary area of the display. When it is determined that the new priority of the third user is higher than the priority of said fourth user, the user terminal may be configured to obtain a higher resolution of visual data associated with the third user. This may be achieved by the user terminal transmitting a request to a network entity to receive visual data associated with said third user. The user terminal may be further configured to transmit a request to the network entity to receive lower resolution visual data associated with said fourth user. The request to receive lower resolution visual data associated with said fourth user may be a request to unsubscribe from receiving visual data associated with said fourth user. As in the case mentioned above, as the user terminal may employ selective subscription to streams of visual data associated with different users on the multi-user calls, this helps to reduce congestion in the network, as only the visual data to be rendered is received by the user terminal.

In response to determining that the new priority of the third user is the same as or lower than the priority of said fourth user, the user terminal does not control the display to render a summary of the visual data associated with said fourth user in the tertiary area of the display and rendering the visual data associated with said third user in the secondary area of the display. In other words, the user terminal does not change the configuration/layout of the rendered visual data in response to a determination that said new priority is the same as and/or lower than the priority of said first user.

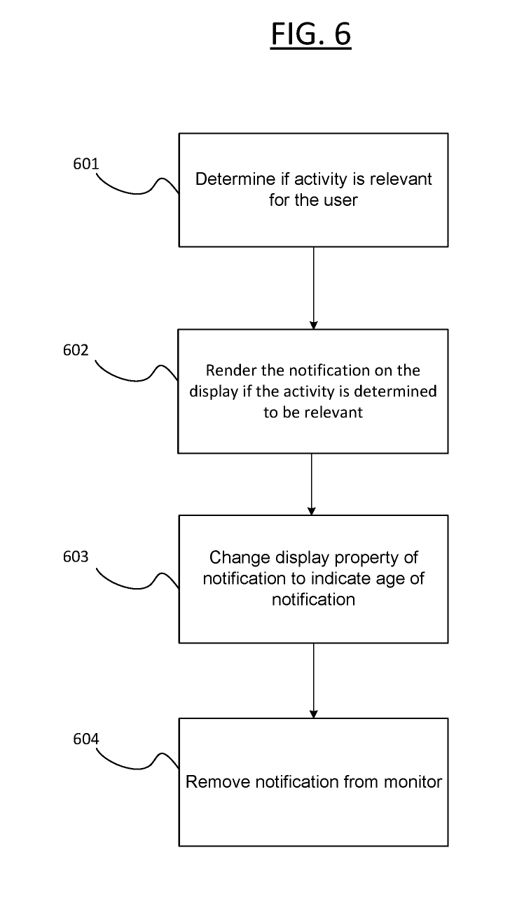

The user terminal may be further configured to control the display to render information identifying at least the most recent activity that has occurred on the call. For example, the display may be further configured to render an indication of any of the following events as notifications: the connection of a user to the multi-user call; the disconnection of a user to the multi-user call; the sharing of a file and/or slideshow presentation through the application through which the multi-user call is being conducted; and an indication of a received message transmitted through the messaging/communication application as part of the multi-user call. The display of notifications is discussed further below in relation to FIG. 6.

The user terminal may be configured to perform a comparison (and/or to determine the priorities) periodically and/or aperiodically. For example, where the comparison is periodic, the comparison may be made every 10 seconds. This comparison may directly affect the positioning of visual data rendered on the display, such that the rendering may be updated every 10 seconds (or no more than every 10 seconds, assuming that there will be some instances in which no change to the user's priorities occurs within a 10 second block). Where the comparison is performed aperiodically, the user terminal may be configured to perform the comparison in response to a detected activity. The user terminal may be configured to only perform the comparison in response to a detected activity.

To assist in alleviating the processing burden on the user terminal, the user terminal may be configured to determine the highest priority user in the lowest and intermediate priority groups, and the lowest priority user in the intermediate and high priority user groups and to only perform priority comparisons for updating the display based on these determined priorities.

The determined priority levels may be determined only in response to a detected activity. At other times, these priority levels may be stored (either in memory local to or remote from the user terminal). The stored priority levels may be aged so as to only reflect activity that has occurred within a predetermined time period. For example, the priorities may be determined such that activities that took place more than 30 seconds ago may be disregarded when making the determination.

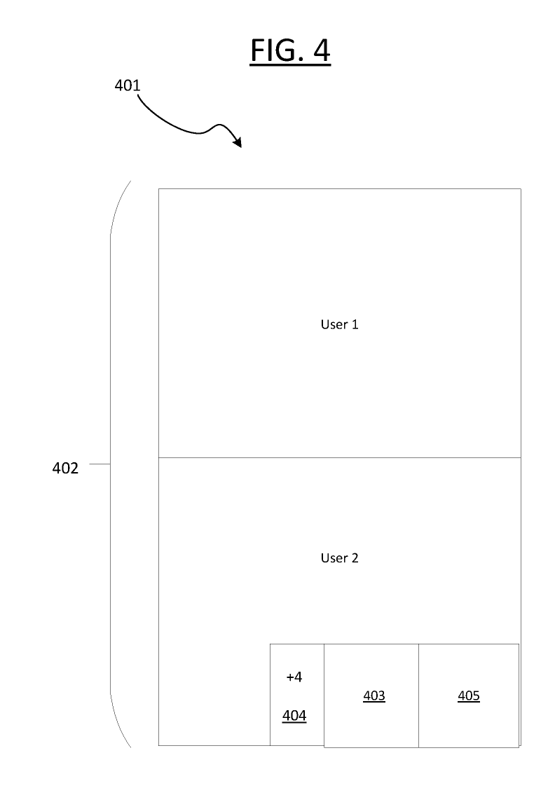

As an example, we further refer to FIGS. 4 and 5A to 5E. These FIGs all illustrate possible renderings on a display screen in accordance with the disclosure above.

FIG. 4 displays a window of a conversation visualisation environment 401. The window of the conversation visualisation environment may be caused to be rendered on a display controlled by a user terminal as a result of code executing on at least one processor to which the user terminal has executable access.

Within the conversation visualisation environment window 401, there is a primary area 402 that is configured to display video data associated with user 1 and user 2 on a multi-user phone call. Within the conversation visualisation environment window 401, there is further a secondary area 403 that is configured to display video data of user 3. The resolution of the video data of user 3 is smaller than that of the resolution of the video data of user 1 and user 2, as the size of the secondary area 403 is much less than the size of the primary area 402 allocated to each of user 1 and user 2.

Immediately adjacent to the secondary area 403, there is a tertiary area 404 in which a summary of the other users on the multi-user call is rendered. In the example of FIG. 4, the summary indicates that there are four more users on the multi-user call who do not have image/video data displayed in the primary and/or secondary area by displaying the graphical symbol “+4”. There is a final area 405 depicted, in which video data associated with the user using the user terminal is provided.

FIGS. 5A to 5E depict possible screen-shots of the conversation visualisation environment 401 following the detection/determination of different events. For consistency, the general areas discussed above in relation to FIG. 4 will, where replicated in FIGS. 5A to 5E, reuse the same reference numerals.

FIG. 5A shows the situation in which one other user (than the user of the user terminal) is currently connected to the call. This user will be known as user 1, and their associated visual data (e.g. video data) is displayed in the entirety of the primary area 402. As user 1 is the first user to participate in the call (from the point of view of the user of the user terminal), user 1 is allocated a priority that places the visual data associated with user 1 in the primary area. Users 2 to 5 are attempting to connect to the call. Visual data associated with user 2 is displayed in the secondary area 403. The tertiary area shows “+3” and a drop down list of the users who are still attempting to connect to the call. A symbol 501 is provided next to each of the users in the summary area to indicate that that user is in the process of connecting to the call. The drop down list may be selectably displayed on activation of a link on the +3 symbol or may be simply displayed without activation of a link.

FIG. 5B shows the situation in which user 2 connects to the multi-user call. The change in activity has increased the priority level associated with user 2. The user terminal has determined that it may render another video within the primary area 402 of the conversation visualisation environment 401 and so the video of user 2 is further shown in the primary area 402 of the display. Video data of user 3 fills the space left by the promotion of user 2 from the secondary area 403 to the primary area 402, such that the video data of user 3 is rendered in the secondary area 403. User 3 has a superposed symbol 501 in the secondary area 403 that indicates that user 3 is still in the process of connecting to the call. The tertiary area 404 shows only two users: user 4 and user 5. Of these two users, only user 5 depicts the symbol 501 indicating that they are still attempting to connect, which means that user 4 has connected.

As user 4 has connected, the priority associated with user 4 has increased. The priority of user 4 is therefore higher than that of user 3, who has yet to connect. Therefore, on comparison of these priorities, the user terminal is configured to swap the positions of users 3 and 4, such that video data associated with video 4 is displayed in the secondary area 403 whilst a summary indicative of user 3 is provided in the tertiary area 404. This scenario is depicted in FIG. 5C. As shown in FIG. 5C, none of the users are superposed with the symbol 501 indicative of a user attempting to connect to the call and are considered to all be connected. As the priority of users 3 to 5 are the same (as the only detected activity associated with any of these three users is the connection to the call), the configuration of the video data remains the same.

FIG. 5D depicts the situation where user 5 speaks briefly. This audio activity increases the priority associated with user 5 relative to the user in the secondary area 403 (i.e. user 4) and so video data associated with user 5 replaces video data associated with user 4 in the secondary area 403. The priority of user 5 is not, at that point, compared to any other user than the user(s) in the secondary area 403.

In FIG. 5E, user 5 has continued to speak. On detection/determination of the higher priority of user 5 after video data associated with user 5 has been rendered in the secondary area 403, the user terminal compares the priority associated with user 5 with that of the smallest priority of the users having video data rendered in the primary area 402 (i.e. users 1 and 2 in the present case). As a result of this comparison, user 2 is demoted such that their associated video data is rendered in the secondary area 403 instead of the larger primary area 402. Where the priorities of the user are the same, the user terminal may apply techniques for sorting the users into their different respective priority groups.

The tertiary area 404 and/or the secondary area may also be used to depict notifications. Alternatively, an area for notifications may be provided in the conversation visualisation environment separately. In the present context, a notification is a visual indication of an activity that has taken place during an audio-visual call. For example, a notification may indicate the connection (and/or disconnection) of a user to a call, the connection (and/or disconnection) of multiple users to a call, the sharing of a file, speaker activity, etc. The notifications rendered on the display may be caused to render for a predetermined time. In other words, a rendered notification is displayed with a fixed duration.

When an event associated with a notification occurs, the user terminal may be configured to cause the display to render the notification instantly (or within a predetermined time frame). This means that the notifications displayed on the screen may be updated more (or less) frequently than the configuration of visual information for users on the call, depending on how many events happen within the time frame. For example, where the comparison is scheduled to occur periodically every 10 seconds, the notifications may be displayed for a fixed duration almost as soon as their associated event is identified.

Where there are multiple notifications to be rendered, the user terminal may cause these to be rendered in a serial queue. The serial queue may be dependent on when the notifications are first rendered, such that new notifications are added to one side of the queue only. When a new event occurs, a notification for that event is pushed into the shared queue notification.

The notification queue may be configured so as to render no more than a predetermined amount of notifications. For example, the queue may be configured such the queue has no more than three notifications rendered at any one time. In this case, if the queue is displaying three notifications and it is determined that a new notification should be rendered on the display, at least the oldest notification may be removed from the queue to form space for the new notification to be rendered. It may be, for example, that in this case all of the three notifications are removed to form space for the new notification to be rendered. This draining of the queue allows the removal of noise on the screen and may help prevent the queue becoming clogged with out-of-date/less useful notifications.

For each notification, the user terminal may be configured (via code being executed on at least one processor) to perform the operation illustrated with respect to FIG. 6.

At 601, the user terminal is configured to check if an activity is still relevant for a user associated with the notification. For example, it may be that users do not seen notifications for events that they have caused and/or that notifications relating to a user that has left the call are no longer considered to be relevant.

At 602, the notification is rendered in the conversation visualisation environment. As mentioned above, this may be in the tertiary area 404, or in another area of the conversation visualisation environment dedicated to the multi-user call.

At 603, the display of the notification is caused to “sleep”. By this, the notification may be caused to change one of its display properties (such as colour) to indicate that the notification is no longer new. For example, the notification may become greyed out. This may be caused to happen, for example, 1 second after first being displayed. The time between initial display and “sleep” of the notification may be dependent on the type of notification, so that notifications considered to be more important (such as connection/disconnection of a user to the call) are displayed for longer than notifications considered to be less important. The importance of a notification may be set by the computer code (and hence by the system designer) and/or may be settable by a user of the user terminal.

At 604, the notification may be removed from the display, such that it is no longer being rendered on the display.

The above-described techniques have especial use in packet communication networks that use the Voice over Internet Protocol (VoIP), which is a set of protocols and methodologies for transmitting audio data over a communication medium.

The above-described techniques have especial use when the visual data is video data. The video data is real-time or near real-time.

The above-described techniques have particular use in a system in which the configuration is automatically rendered by a user terminal. For example, a user terminal may be configured, through the executing computer code, to automatically decide the configuration/layout of the displayed visual data respectively associated with at least some of the users on a multi-user call. The user operating the user terminal may override the automatic layout, following receipt by the user terminal of a user input from the user indicative of this.

In the above-described embodiments, the user terminal may be configured to only display the secondary area for calls that are not audio only calls i.e. for calls that are audio-visual calls.

According to the above, there is provided a method comprising: allocating each user participating in a multi-user call to a first group, a second group, or a third group in dependence on a respective first priority associated with each user; causing a display to render image data representative of respective users in the first group in a primary area of the display and to render image data representative of respective users in the second group in a secondary area of the display, wherein users in a third group do not have image data rendered in either of the primary and secondary areas; and re-allocating each user participating in the multi-user call to the first group, the second group, or the third group in dependence on a respective second priority associated with each user, such that users immediately previously allocated to the third group are not re-allocated to the first group.

The primary area of the display may be larger than the second area of the display.

The method may further comprise: determining respective second priorities for each user on the multi-user call; comparing the second priority of a first user in the first group with the second priority of a second user in the second group; and controlling a display to render the image data associated with the first user in the secondary area and the image data of the second user in the primary area when it is determined that said the second priority of the second user is higher than the second priority of the first user. When it is determined that said first new priority is higher than the priority of said first user, the method may further comprise: causing a user terminal to receive higher resolution image data associated with said second user than is currently being received by the user terminal; and causing a user terminal to receive lower resolution image data associated with said first user than is currently being received by the user terminal.

The method may further comprise: determining respective second priorities for each user on the multi-user call; comparing the second priority of a third user in the third group with the second priority of a second user in the second group; and controlling a display to render the image data associated with the third user in the secondary area when it is determined that said second priority of the third user is higher than the second priority of the second user. When it is determined that said second priority of the third user is higher than the priority of the second priority of the second user, the method may further comprise: causing a user terminal to receive image data associated with said third user by the user terminal; and causing the user terminal to receive lower resolution image data associated with said second user by the user terminal. Said request to receive lower resolution image data associated with said second user may be a request to unsubscribe from receiving image data associated with said second user.

Visual data representative of the third group may be caused to be rendered in a tertiary area of the display as at least one of: a graphical illustration of the users in the third group; a drop down box that, on activation of a link, opens to reveal at least information identifying the users in the third group; and a scrollable list of information identifying the users in the third group.

The method may further comprise: controlling the display to render information identifying at least the most recent activity that has occurred on the call.

The method may further comprise: determining the number of users in the first group in dependence on the total size of the display allocated to rendering image data relating to the multi-user call.

The method may further comprise: determining the number of users in the first group in dependence on an input from the user that indicates a number of users to render image data for in the primary area of the display.

The method may further comprising determining, the respective priorities for every user participating in the multi-user call in dependence on a conversation activity associated with each user on the multi-user call.

The priorities may be determined by performing an integral of a metric relating to the amount of audio data received from a user in a preceding time period. When audio received from a user drops, the metric may be smoothed by a sine function over a multiple of the frequency with which the priorities are updated.

The allocating and re-allocating may be such that there is only one user in the second group.

The method may further comprise: controlling the display to render a notification of a communication event that has occurred during the multi-user call. The communication event may be at least one of: the connection of a user to the multi-user call; the disconnection of a user to the multi-user call; the sharing of a file and/or slideshow presentation through the application through which the multi-user call is being conducted; and an indication of a received message transmitted through the messaging/communication application as part of the multi-user call. The notifications may be rendered on the display as a serial queue such that notifications associated with the most recent communication events are loaded into the queue via only one side.

There is further provided an apparatus comprising: at least one processor; and at least one memory comprising code that, when executed on the at least one processor, causes the apparatus to: allocate each user participating in a multi-user call to a first group, a second group, or a third group in dependence on a respective first priority associated with each user; cause a display to render image data representative of respective users in the first group in a primary area of the display and to render image data representative of respective users in the second group in a secondary area of the display, wherein users in a third group do not have image data rendered in either of the primary and secondary areas; and re-allocate each user participating in the multi-user call to the first group, the second group, or the third group in dependence on a respective second priority associated with each user, such that users immediately previously allocated to the third group are not re-allocated to the first group.

There is further provided a user terminal comprising: at least one processor; and at least one memory comprising code that, when executed on the at least one processor, causes the user terminal to perform any of the steps of the above-mentioned method.

There is further provided a computer program product comprising computer executable instructions, which when executed by a computer, cause the computer to perform each of the method of any of claims 1 to 18.

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof. In the case of a software implementation, the module, functionality, or logic represents program code that performs specified tasks when executed on a processor (e.g. CPU or CPUs). Where a particular device is arranged to execute a series of actions as a result of program code being executed on a processor, these actions may be the result of the executing code activating at least one circuit or chip to undertake at least one of the actions via hardware. At least one of the actions may be executed in software only. The program code can be stored in one or more computer readable memory devices. The features of the techniques described below are platform-independent, meaning that the techniques may be implemented on a variety of commercial computing platforms having a variety of processors.

For example, the user terminals configured to operate as described above may also include an entity (e.g. software) that causes hardware of the user terminals to perform operations, e.g., processors functional blocks, and so on. For example, the user terminals may include a computer-readable medium that may be configured to maintain instructions that cause the user terminals, and more particularly the operating system and associated hardware of the user terminals to perform operations. Thus, the instructions function to configure the operating system and associated hardware to perform the operations and in this way result in transformation of the operating system and associated hardware to perform functions. The instructions may be provided by the computer-readable medium to the user terminals through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Computer-readable storage media do not include signals per se. Examples of a computer-readable storage medium include a random-access memory (RAM), read-only memory (ROM), an optical disc, flash memory, hard disk memory, and other memory devices that may us magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method comprising:
allocating each user participating in a multi-user call to a first group, a second group, or a third group in dependence on a respective first priority associated with each user;
causing a display to render image data representative of respective users in the first group in a primary area of the display and to render image data representative of respective users in the second group in a secondary area of the display, wherein users in a third group do not have image data rendered in either of the primary and secondary areas; and
re-allocating each user participating in the multi-user call to the first group, the second group, or the third group in dependence on a respective second priority associated with each user, such that users immediately previously allocated to the third group are not re-allocated to the first group.

2. A method as claimed in claim 1, wherein the primary area of the display is larger than the second area of the display.

3. A method as claimed in claim 1, further comprising:
determining respective second priorities for each user on the multi-user call;
comparing the second priority of a first user in the first group with the second priority of a second user in the second group; and
controlling a display to render the image data associated with the first user in the secondary area and the image data of the second user in the primary area when it is determined that said the second priority of the second user is higher than the second priority of the first user.

4. A method as claimed in claim 3, further comprising:
when it is determined that said first new priority is higher than the priority of said first user:
causing a user terminal to receive higher resolution image data associated with said second user than is currently being received by the user terminal; and
causing a user terminal to receive lower resolution image data associated with said first user than is currently being received by the user terminal.

5. A method as claimed in claim 1, further comprising:
determining respective second priorities for each user on the multi-user call;
comparing the second priority of a third user in the third group with the second priority of a second user in the second group; and
controlling a display to render the image data associated with the third user in the secondary area when it is determined that said second priority of the third user is higher than the second priority of the second user.

6. A method as claimed in claim 5, further comprising:
when it is determined that said second priority of the third user is higher than the priority of the second priority of the second user:
causing a user terminal to receive image data associated with said third user by the user terminal; and
causing the user terminal to receive lower resolution image data associated with said second user by the user terminal.

7. A method as claimed in claim 6, wherein said request to receive lower resolution image data associated with said second user is a request to unsubscribe from receiving image data associated with said second user.

8. A method as claimed in claim 1, wherein visual data representative of the third group is caused to be rendered in a tertiary area of the display as at least one of:
a graphical illustration of the users in the third group;
a drop down box that, on activation of a link, opens to reveal at least information identifying the users in the third group; and
a scrollable list of information identifying the users in the third group.

9. A method as claimed in claim 1, further comprising:
controlling the display to render information identifying at least the most recent activity that has occurred on the call.

10. A method as claimed in claim 1, further comprising:
determining the number of users in the first group in dependence on the total size of the display allocated to rendering image data relating to the multi-user call.

11. A method as claimed in claim 1, further comprising:
determining the number of users in the first group in dependence on an input from the user that indicates a number of users to render image data for in the primary area of the display.

12. A method as claimed in claim 1, further comprising determining, the respective priorities for every user participating in the multi-user call in dependence on a conversation activity associated with each user on the multi-user call.

13. A method as claimed in claim 1, wherein the priorities are determined by performing an integral of a metric relating to the amount of audio data received from a user in a preceding time period.

14. A method as claimed in claim 13, wherein when audio received from a user drops, the metric is smoothed by a sine function over a multiple of the frequency with which the priorities are updated.

15. A method as claimed in claim 1, wherein the allocating and re-allocating is such that there is only one user in the second group.

16. A method as claimed in claim 1, further comprising:
controlling the display to render a notification of a communication event that has occurred during the multi-user call.

17. A method as claimed in claim 16, wherein the communication event is at least one of: the connection of a user to the multi-user call; the disconnection of a user to the multi-user call; the sharing of a file and/or slideshow presentation through the application through which the multi-user call is being conducted; and an indication of a received message transmitted through the messaging/communication application as part of the multi-user call.

18. A method as claimed in claim 16, wherein the notifications are rendered on the display as a serial queue such that notifications associated with the most recent communication events are loaded into the queue via only one side.

19. An apparatus comprising:
at least one processor; and
at least one memory comprising code that, when executed on the at least one processor, causes the apparatus to:
allocate each user participating in a multi-user call to a first group, a second group, or a third group in dependence on a respective first priority associated with each user;
cause a display to render image data representative of respective users in the first group in a primary area of the display and to render image data representative of respective users in the second group in a secondary area of the display, wherein users in a third group do not have image data rendered in either of the primary and secondary areas;
re-allocate each user participating in the multi-user call to the first group, the second group, or the third group in dependence on a respective second priority associated with each user, such that users immediately previously allocated to the third group are not re-allocated to the first group.

20. One or more computer-readable storage media storing a computer program product comprising computer executable instructions, which when executed by a computer, cause the computer to perform operations comprising:
allocating each user participating in a multi-user call to a first group, a second group, or a third group in dependence on a respective first priority associated with each user;
causing a display to render image data representative of respective users in the first group in a primary area of the display and to render image data representative of respective users in the second group in a secondary area of the display, wherein users in a third group do not have image data rendered in either of the primary and secondary areas; and
re-allocating each user participating in the multi-user call to the first group, the second group, or the third group in dependence on a respective second priority associated with each user, such that users immediately previously allocated to the third group are not re-allocated to the first group.
